(19) United States
(12) Patent Application Publication
(10) Pub. No.: US 2005/0049968 A1
(43) Pub. Date: Mar. 3, 2005

(54) Network-based system employing an application server that provides integrated multiparty invoice processing

(76) Inventor: Hervon Porter, Stratford, CT (US)

Correspondence Address: GORDON & JACOBSON, P.C., 60 LONG RIDGE ROAD, SUITE 407, STAMFORD, CT, 06902, US

(21) Appl. No.: 10/647,755

(22) Filed: Aug. 25, 2003

(51) Int. Cl. G06F 17/60

(52) U.S. Cl. 705/40

(57) ABSTRACT

A system and corresponding method for electronic presentment of bills and invoices related to goods and/or services provided by a first entity to a second entity includes a first mechanism for authenticating at least one first-entity-class user, and a second mechanism for authenticating at least one second-entity-class user. An application server includes a first application component that interacts in real-time over a network with an authenticated first-entity-class user to enter, create, maintain, and store billing information and related invoices pertaining to at least one second entity. A second application component interacts in real-time over the network with an authenticated second-entity-class user to access portions of the billing information and related invoices pertaining to the authenticated second-entity-class user. The first application component and the second application component operate in conjunction with data security logic to selectively control first-entity class user access and second-entity-class user access to the billing information and related invoices maintained by the system.

### BACKGROUND OF THE INVENTION

1. Field of the Invention

This invention relates broadly to electronic-based commerce systems and methods. More particularly, this invention relates to electronic-based invoicing systems and methods.

2. State of the Art

In a typical commercial transaction between a seller of goods and/or services and a buyer of such goods and services, the seller creates an invoice for such goods and services that is presented to the buyer for payment by the buyer. Traditionally, the invoice is created by the seller, printed out in paper form and mailed to buyer. Upon receipt, the invoice is typically routed through an approval process at the buyer (requiring review by one or more individuals or departments within the buyer's organization). The invoice may be disputed by the buyer (requiring adjustment to the invoice, and the process begins again) or may be approved by the buyer. Once payment is authorized, the buyer issues a payment instrument (such as a check) and sends the payment instrument to the seller, seller's bank, or other entity of the seller for payment processing. This entire process may take several weeks and requires separate accounting records to be kept and harmonized at both the seller (accounts receivable) and the buyer (accounts payable).

With the advent of the Internet (and other distributed network technologies), electronic-commerce systems have been developed that streamline the traditional invoicing process by enabling electronic presentment of invoices as well as electronic payment of such invoices. An example of such a system is described in U.S. Patent Application Publication US 2003/0004874, published Jan. 2, 2003. In this system, a biller system loads a batch invoice file into the system via an invoice loader. The invoices of the batch invoice file are loaded into a database. An application server enables a biller system user operating a web browser to interact with the application server over the Internet. Such biller-side interaction enables querying the invoices stored in the database, displaying the details of a selected invoice, sending messages (such as text messages and e-mail messages) to the payer associated with an invoice, adjusting and allowing an invoice, and performing other actions associated with the stored invoices. In addition, the application server enables a payer system user operating a web browser to interact with the application server over the Internet. Such payer-side interaction enables querying the invoices stored in the database, displaying the details of a selected invoice, reviewing and approving part or all of an invoice, initiating payment of an invoice, and performing other actions associated with the stored invoices. Such a system enables efficient presentment of invoices to the payer (buyer) and efficient payment of such invoices; however, the system requires a separate and distinct application executed by the biller (seller) for managing the information from which the invoices are derived and for creating invoices. This increases the total cost of the solution.

Thus, there remains a need in the art for an improved electronic-commerce system that provides for seller-side processing that enables maintenance of billing information and creation of invoices derived from such billing information as well as buyer-side processing that enables efficient approval and payment of invoices, to thereby provide for a lower cost electronic-based invoicing solution.

### SUMMARY OF THE INVENTION

It is therefore an object of the invention to provide an improved electronic-commerce system that provides seller-side processing that enables maintenance of billing information and creation of invoices derived from such billing information as well as buyer-side processing that enables efficient approval and payment of invoices.

It is another object of the invention to provide such an improved electronic-commerce system utilizing an application server framework that provides for network-based seller-side access as well as network-based buyer-side access.

It is a further object of the invention to provide such an improved electronic-commerce system wherein seller-side access and buyer-side access occur in real time over network connections to an application server framework.

In accord with these objects, which will be discussed in detail below, a system (and corresponding method) operates in conjunction with the sale of goods and/or services provided by a first entity to a second entity. The system (and corresponding method) provides for electronic presentment of bills and invoices related to such sales/transactions. It includes a first means for authenticating at least one first-entity-class user and second means for authenticating at least one second-entity-class user. An application server includes a first application component that interacts in real-time over a network with an authenticated first-entity-class user to enter, create, maintain, and store billing information and related invoices pertaining to at least one second entity. A second application component interacts in real-time over the network with an authenticated second-entity-class user to access portions of the billing information and related invoices pertaining to the authenticated second-entity-class user. The first application component and the second application component operate in conjunction with data security logic to selectively control first-entity class user access and second-entity-class user access to the billing information and related invoices maintained by the system.

It will be appreciated that electronic-based invoicing systems in accordance with the present invention enables efficient approval and payment of invoices. Moreover, the highly integrated architecture of such systems provides for a lower cost invoicing solution to both sellers and buyers and thus opens up new markets for such advanced invoicing functionality.

According to the preferred embodiment of the invention, the first application component enables access to particular billing information by at least one authenticated second-entity-class user in response to finalization of the particular billing information, wherein the finalization is accomplished by interaction with an authenticated first-entity-class user. Moreover, the first application component and second application component are preferably adapted such that the particular billing information cannot be added to an invoice until approved by an authenticated second-entity-class user. In addition, the first application component preferably enables access to particular invoice information by at least one authenticated second-entity-class user in response to posting of the particular invoice information, which is accomplished by interaction over the network with an authenticated first-entity-class user.

Additional objects and advantages of the invention will become apparent to those skilled in the art upon reference to the detailed description taken in conjunction with the provided figures.

### BRIEF DESCRIPTION OF THE DRAWINGS

FIG. 1 is a block diagram of an electronic bill presentment and invoice processing system in accordance with the present invention;

FIG. 2 is a block diagram of the functionality provided by the subscriber-administrator logic of the application server of FIG. 1 in accordance with the present invention.

FIGS. 3A-3E are pictorial illustrations of exemplary graphical user interfaces that may be displayed at the browser-based subscriber-administrator system as part of the processing provided by the subscriber-administrator logic of FIG. 2 in accordance with the present invention.

FIGS. 4A-4I are pictorial illustrations of exemplary graphical user interfaces (or reporting view(s)) that may be displayed at the browser-based subscriber-administrator system as part of the processing provided by the subscriber-administrator logic of FIG. 2 in accordance with the present invention.

FIG. 5 is a block diagram of the functionality provided by the subscriber-staff logic of the application server of FIG. 1 in accordance with the present invention.

FIG. 6 is a block diagram of the functionality provided by the client-administrator logic of the application server of FIG. 1 in accordance with the present invention.

FIGS. 7A-7D are pictorial illustrations of exemplary graphical user interfaces (or reporting view(s)) that may be displayed at the browser-based client-administrator system as part of the processing provided by the client-administrator logic of FIG. 6 in accordance with the present invention.

FIG. 8 is a block diagram of the functionality provided by the client-staff logic of the application server of FIG. 1 in accordance with the present invention.

FIG. 9 is a schematic diagram that illustrates various states of a billing entry through the invoicing process carried out by the invoicing system of FIG. 1 in accordance with the present invention.

FIG. 10 is a schematic diagram that illustrates various states of an invoice through the invoicing process carried out by the invoicing system of FIG. 1 in accordance with the present invention.

### DETAILED DESCRIPTION OF THE PREFERRED EMBODIMENTS

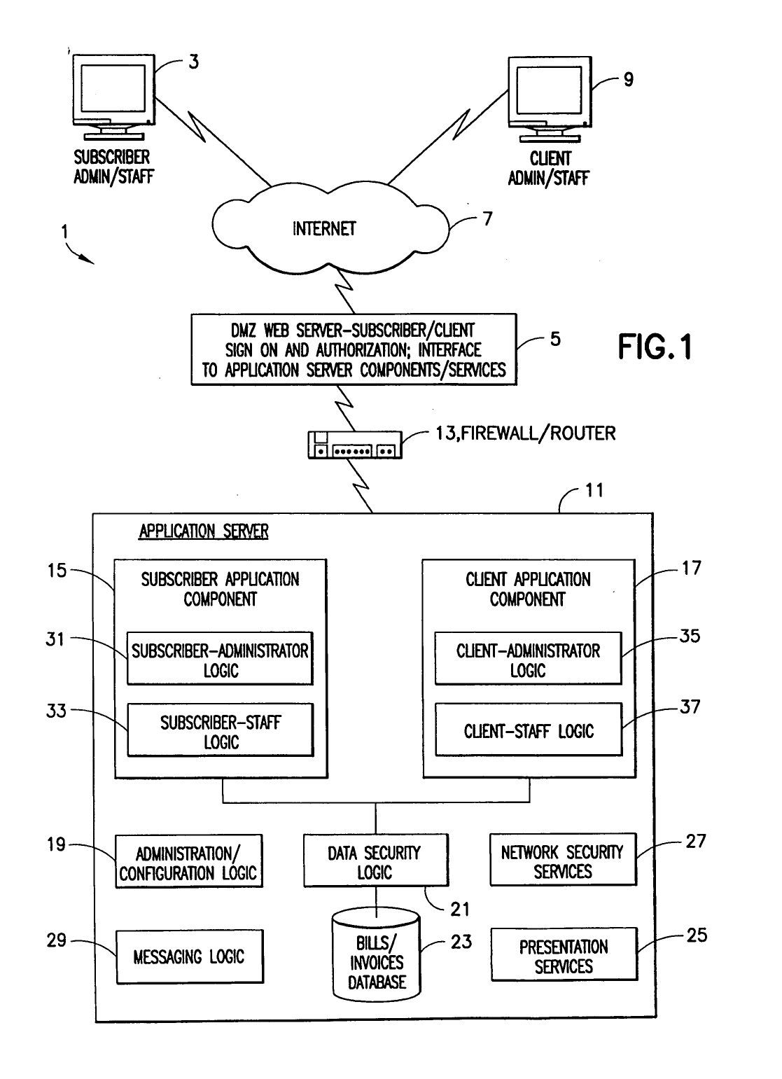

Turning now to FIG. 1, there is shown the architecture of an electronic invoicing system 1 in accordance with the present invention. There are two classes (denoted “Subscribers” and “Clients”) of users of the system. One or more Subscribers, which belong to a Subscriber entity, access the system over a network (such as the Internet) to enter/create, update, store and view billing information (in electronic form) that is related to goods and/or services provided to one or more Clients. One or more Subscribers also access the system over the network to electronically present such billing information to the appropriate Client for review and approval by the Client. One or more Clients, which belong to a Client entity, access the system to review and approve (or disapprove) the bills electronically-presented thereto by the Subscriber(s). In this manner, the system enables centralized creation and management of the billing information and invoices by the Subscriber(s) as well as network-based collaboration that enables efficient presentation, approval, and possibly payment of invoices by the Client(s).

The Subscriber(s) of the system have a hierarchical logical organization including one or more Subscriber Administrators and zero or more Subscriber Staff Members. The Subscriber Administrator(s) has full access to the billing information maintained by the system for the particular Subscriber, and can create and maintain certain user-configurable aspects of the system for the particular Subscriber. The Subscriber Staff Member(s) are created and maintained by the Subscriber Administrator(s) and have limited access to the billing information maintained by the system for the particular Subscriber. For example, in the preferred embodiment of the present invention, the Subscriber Staff Member can only view and update billing information that was originally created by the Subscriber Staff Member.

Similarly, the client(s) of the system have a hierarchical logical organization including one or more Client Administrators and zero or more Client Staff Members. The Client Administrator(s) has limited access (for example, access granted only upon submission by the Subscriber to the Client for approval as described below) to the billing information maintained by the system for the particular Client, and can create and maintain certain user-configurable aspects of the system for the particular Client. The Client Staff Member(s) are created and maintained by the Client Administrator(s) and have limited access to the billing information maintained by the system for the particular Client. For example, in the preferred embodiment of the present invention, the Client Staff Member can only view and update billing information that was submitted by the Subscriber to the Client for approval and that is associated with a location (e.g., Department, Division, Branch Office, etc.) of the Client submitted by the Subscriber to the Client for approval originally created by the Subscriber Staff Member.

As shown in FIG. 1, the Subscriber Administrator(s) and Subscriber Staff (commonly referred to herein as Subscriber Administrator/Staff) utilize a web browser executing on a computing device 3 to connect to a web server 5 over the network 7 (e.g., Internet). Similarly, the Client Administrator(s) and Client Staff (commonly referred to herein as Subscriber Administrator/Staff) utilize a web browser executing on a computing device 9 to connect to the web server 5 over the network 7. Preferably, the browser-based interaction between the computing devices 3, 5 and the web server 5 occur over TCP/IP sessions established therebetween over which are communicated HTML-based (and possibly XML-based) documents and commands as well as other messages, commands and data. The web server 5 enables login and authentication of Subscriber Administrator/Staff via interaction with the Subscriber system 3 as well as login and authentication of Client Administrator/Staff via interaction with the Client system 9. Such login and authentication can utilize password-based authentication, operating system-based authentication (e.g., NTLM or Kerberos); services-based authentication (e.g., Microsoft Passport authentication), certificate-based authentication, or any other authentication scheme. Once a user session has been authorized (whether it be a Subscriber Administrator/Staff session or Client Administrator/Staff session), the web server 5 communicates with an Application Server 11 to build dynamic web page(s) based on data supplied by the Application Server 11 and serve the dynamic web page(s) to the Subscriber Administrator/Staff web browser (or the Client Administrator/Staff web browser) as requested, and forward (and/or transform) data supplied by the Subscriber Administrator/Staff web browser (or Subscriber Administrator/Staff web browse) to the Application Server 11 as needed. Preferably, the web server 5 is located in a “demilitarized zone” (DMZ) provided with a firewall router 13. In, this configuration, the firewall/router 13 enables authorized communication between the web server 5 and the Application Server 11 (typically utilizing a secure socket layer (SSL) interface or an IPSec interface), while blocking unauthorized communication requests to the Application Server 11. In addition, the web server 5 preferably utilizes style sheets to build the HTML documents (and XML documents) for presentment to the Subscriber Administrator/Staff web browser (or Subscriber Administrator/Staff web browse). The web server 5 may be realized by commercially available HTTP servers, such as the Apache Web Server, Microsoft Internet Information Server, and Sun ONE Web Server.

The Application Server 11 includes a Subscriber Application Component 15, a Client Application Component 17, Administration/Configuration Logic 19, Data Security Logic 21, a Database 23 storing bills and invoices, Presentation Services 25, Network Security Services 27, and possibly Messaging Logic 29. The Administration/Configuration Logic 19 provides for system management and configuration of the Application Server 11. The Presentation Services 25 are facilities that enable delivering dynamic content to client browsers. Preferably, the Presentation Services 25 support Active Server Pages, JavaServer pages, server-side scripting such as Perl, CGI, PL/SQL scripting, etc. The Network Security Services 27 provides facilities that enable maintaining network security (such as SSL-based or IPSec-based encryption and authentication facilities). Preferably, the Application Server 11 is realized by a commercially-available software framework, such as the WebLogic Platform commercially available from BEA Systems of San Jose, Calif., the Websphere Application Server commercially available from IBM, Windows Server Systems commercially available from Microsoft Corporation of Redmond, Wash., or the SUN ONE Application Server commercially available from Sun Microsystems of Santa Clara, Calif.

The Subscriber Application component 15, works in conjunction with the Presentation Services 25 and other components of the Application Server 11, to provide dynamic content to the web server 5 for delivery to the browser-based Subscriber Administrator/Staff system 3. The Subscriber Application component 15 also encodes business logic that represents the Subscriber-side part of the invoicing process (e.g., the creation, update, storage, and finalization of invoices on the part of the Subscriber Administrator/Staff). It also updates state information that represents the status of invoices in conjunction with this invoicing process.

The Client Application component 17, works in conjunction with the Presentation Services 25 and other components of the Application Server 11, to provide dynamic content to the web server 5 for delivery to the browser-based Client Administrator/Staff system 9. The Client Application component 17 also encodes business logic that represents the Client-side part of the invoicing process (e.g., the review, approval/rejection, and payment of invoices on the part of the Client Administrator/Staff). It also updates state information that represents the status of invoices in conjunction with this invoicing process.

The billing information and invoices created and updated during the invoicing process is stored in the database 23. The database 23 can be realized by files stored by the application server 17. Alternatively, the database 23 can be realized by a relational database that is part of the application server (as shown), or coupled thereto by an appropriate database connector interface.

Data Security Logic 21 provides facilities that enable controlled-access to the information stored in the database 23. In the invoicing system of the present invention, the Data Security Logic 21 provides user-level access control to the billing information and invoices that are created and maintained by the Subscriber-side part of the invoicing process. For example, it is preferred that such information remain inaccessible to the Client Administrator/Staff until an invoice is finalized for submission to the Client entity. In addition, it is preferred that the Application Server 11 include Messaging Logic 29 that provides facilities that support messaging between Subscriber Administrator/Staff and Client Administrator/Staff. The messaging can be in the form of text messages, instant messages, or e-mail messages.

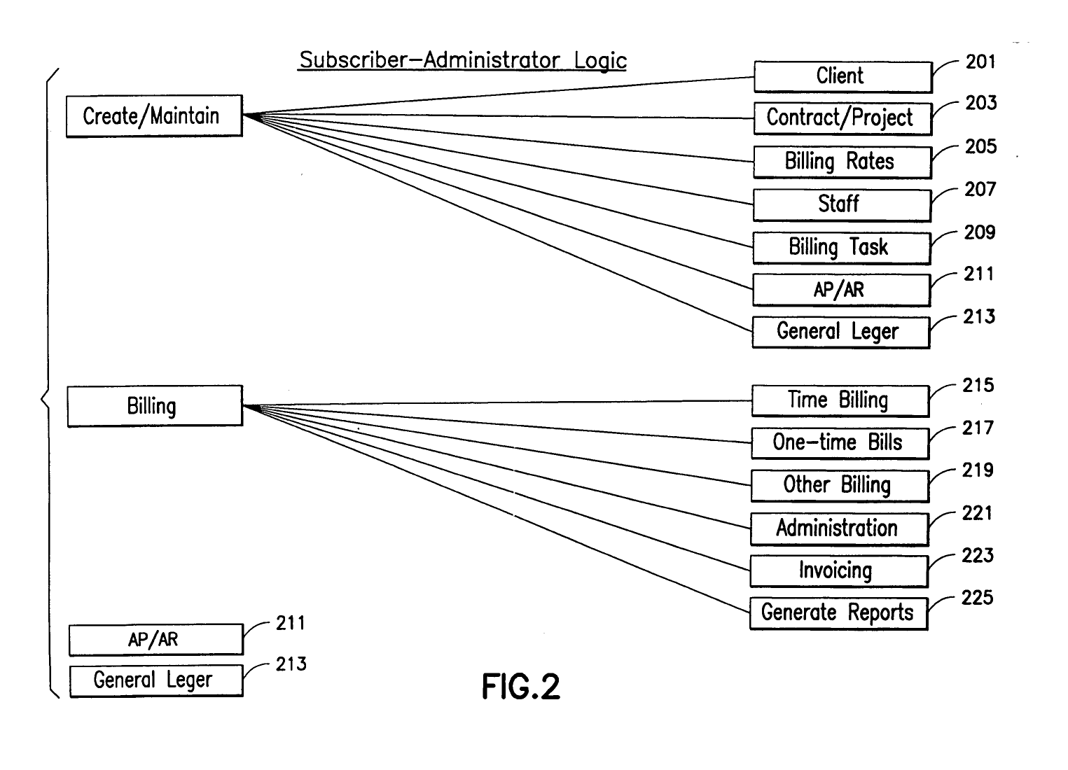

The processing functionality provided by the Subscriber Application Component 15 is preferably logically partitioned into two parts: Subscriber-Administrator logic 31 and Subscriber-Staff logic 33. The Subscriber-Administrator logic 31 interacts with a browser-based Subscriber-Administrator user to perform various functions as part of the Subscriber-side invoice processing. Examples of such functions are described below with respect to FIGS. 2 through 4I. The Subscriber-Staff logic 33 interacts with a browser-based Subscriber-Staff user to perform various functions as part of the Subscriber-side invoice processing. Examples of such functions are described below with respect to FIG. 5.

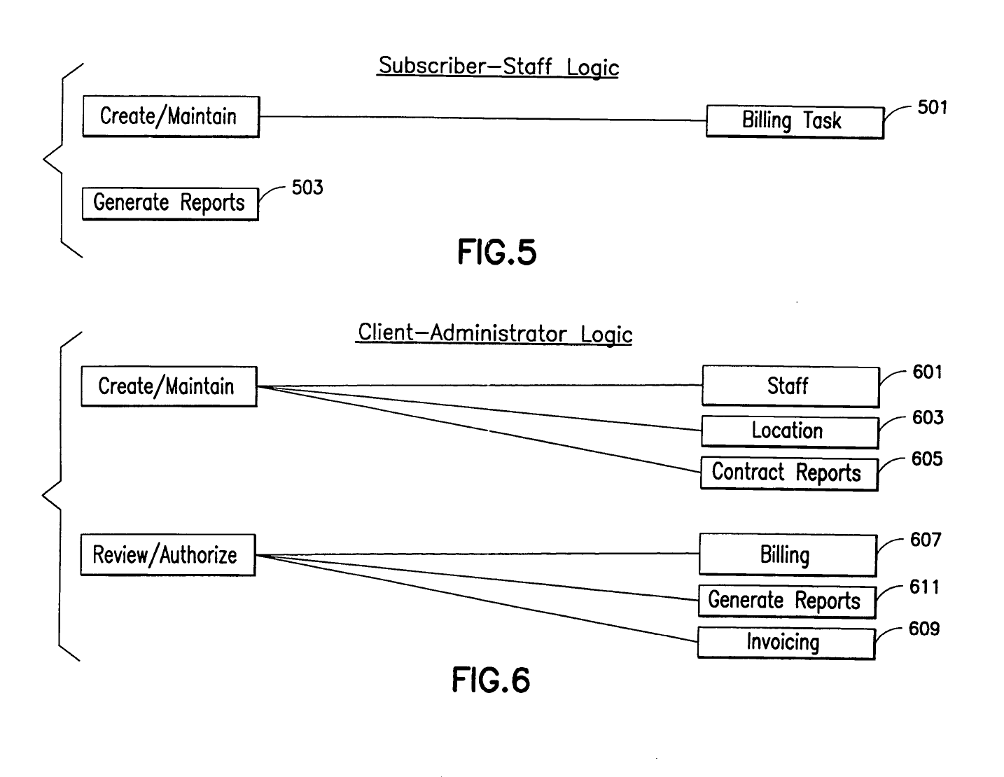

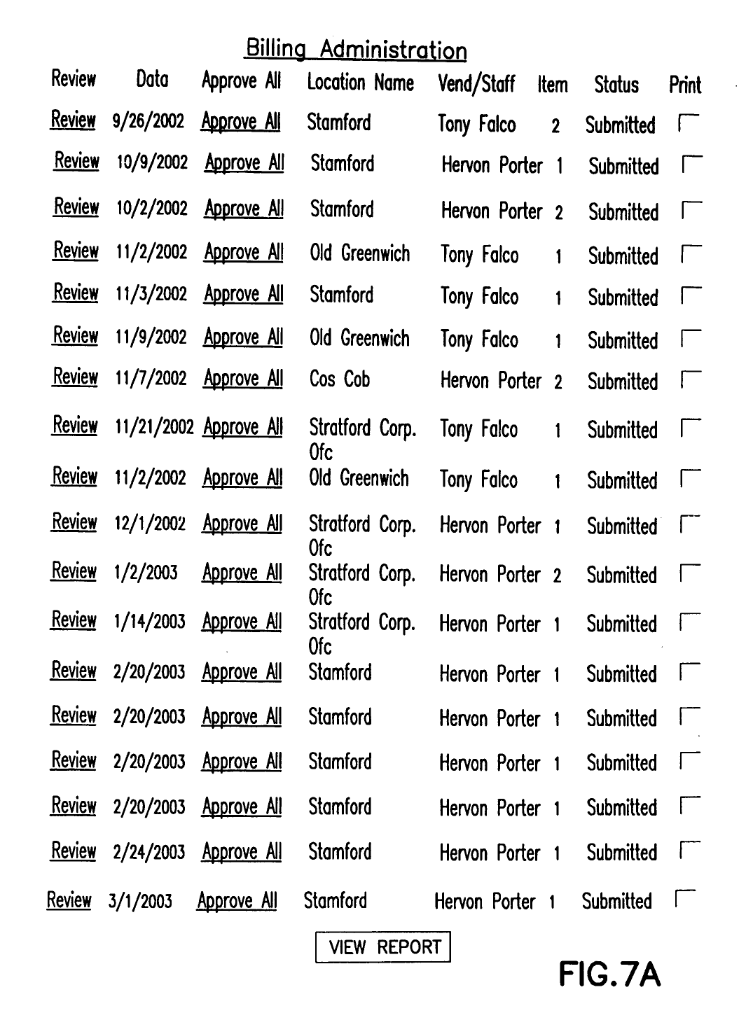

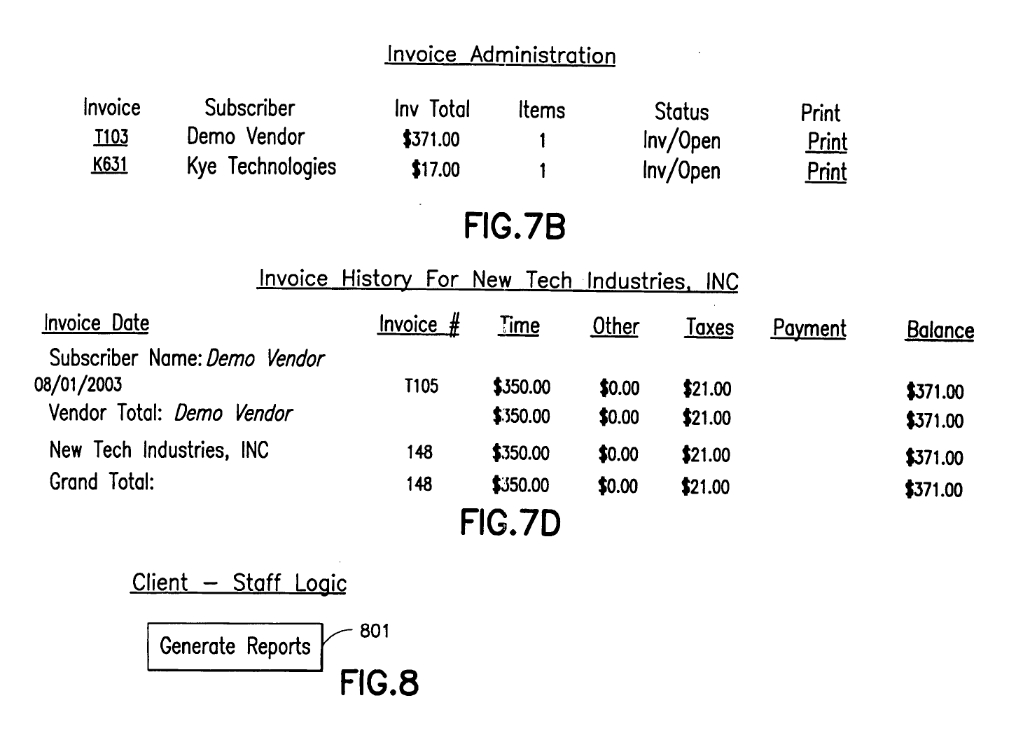

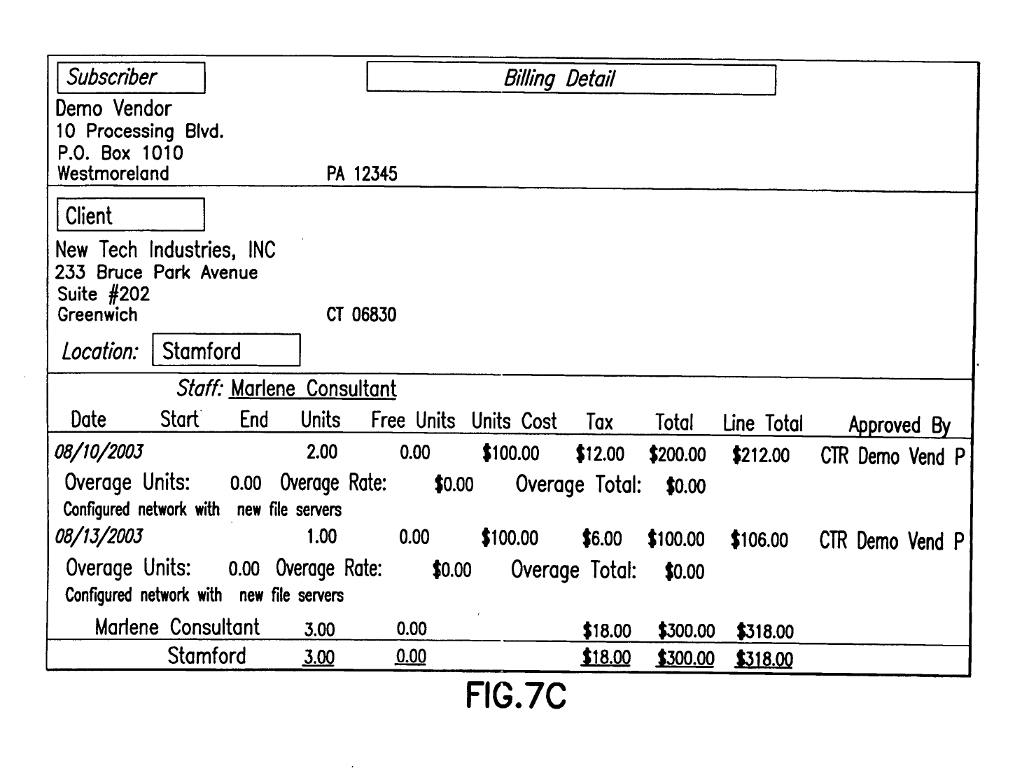

Similarly, the processing functionality provided by the Client Application Component 17 is preferably logically partitioned into two parts: Client-Administrator logic 35 and Client-Staff logic 37. The Client-Administrator logic 35 interacts with a browser-based Client-Administrator user to perform various functions as part of the Client-side invoice processing. Examples of such functions are described below with respect to FIGS. 6 through 7D. The Client-Staff logic 37 interacts with a browser-based Client-Staff user to perform various functions as part of the Client-side invoice processing. Examples of such functions are described below with respect to FIG. 8.

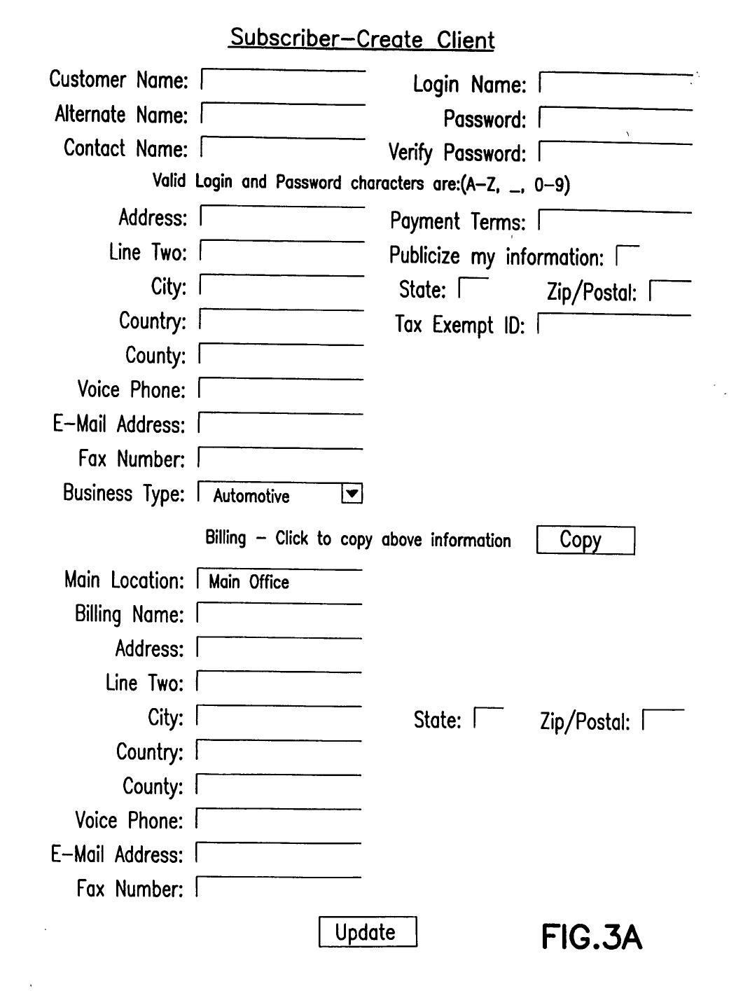

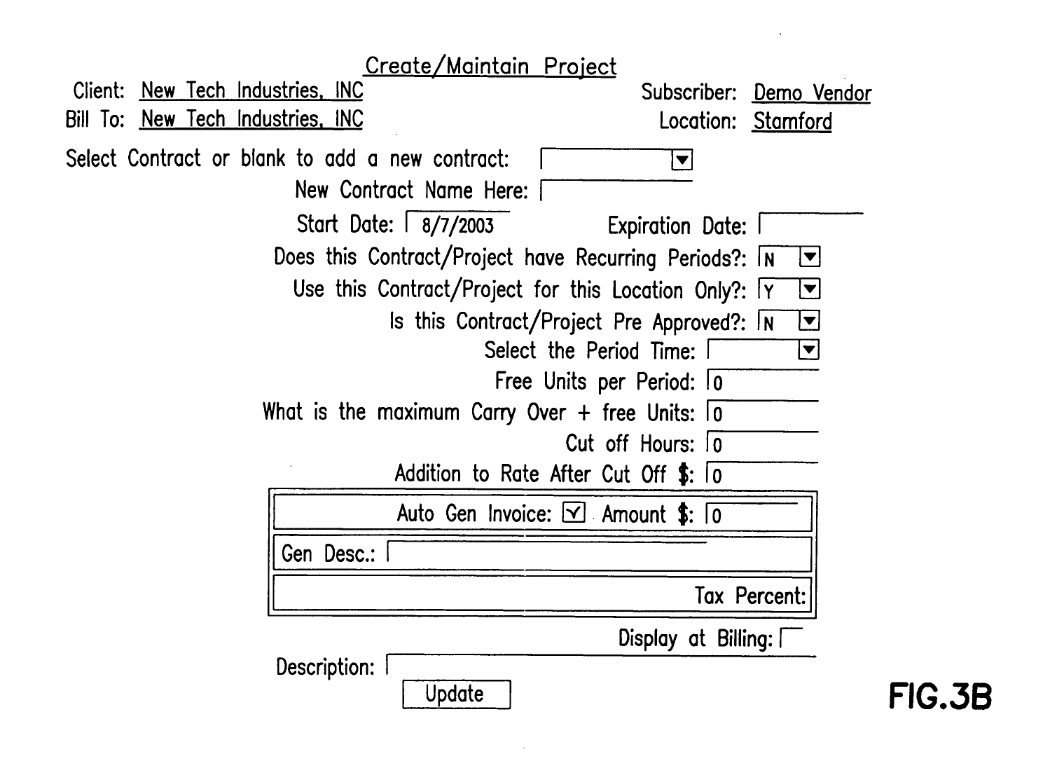

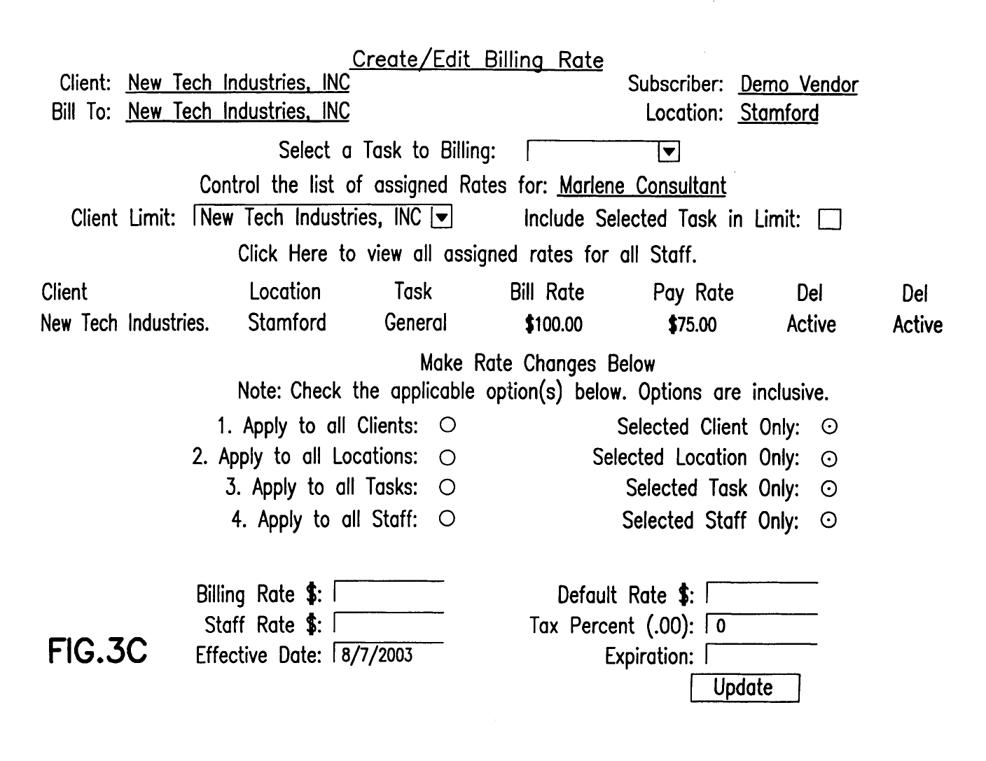

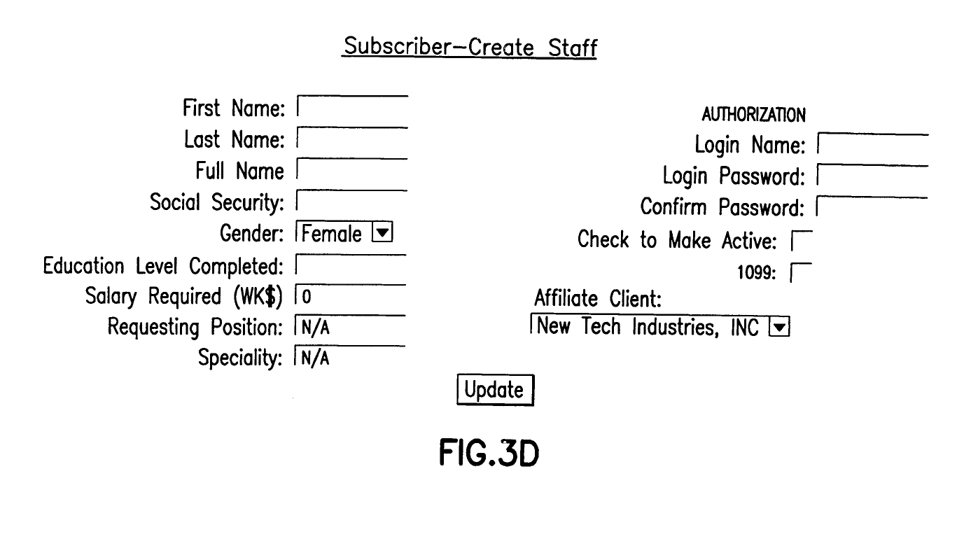

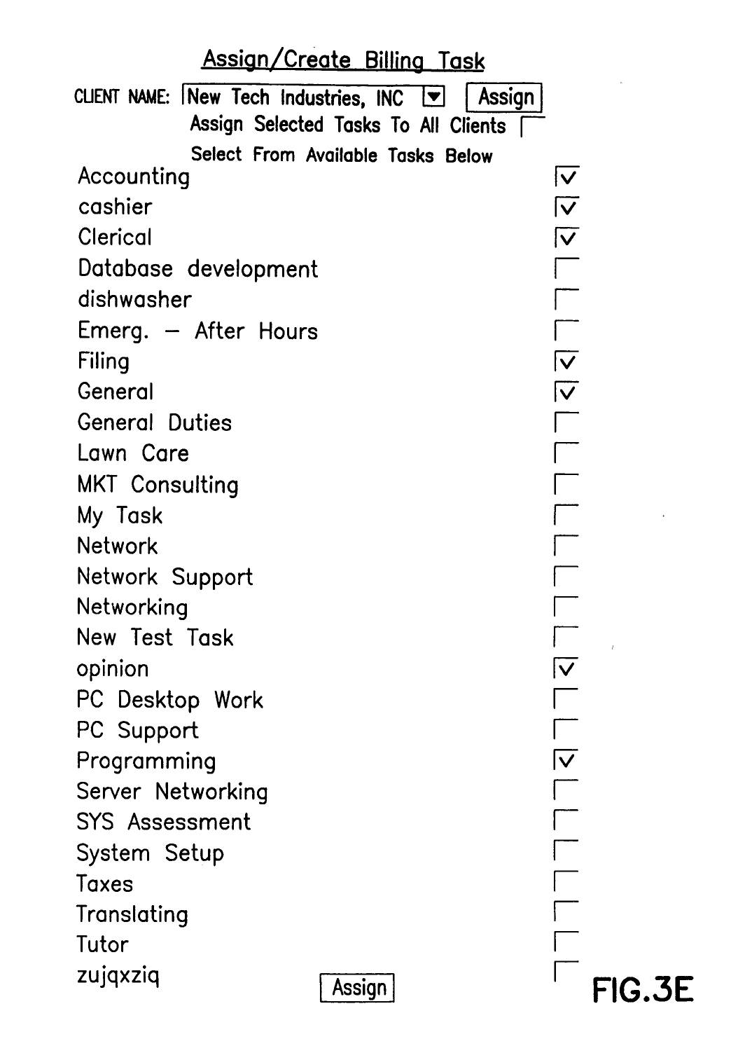

Turning now to FIG. 2, there is shown a high-level schematic representation of exemplary functions provided by the Subscriber-Administrator logic 3 1. Such functions include a block 201 that interacts with a browser-based Subscriber-Administrator user to create a Client entity. An example of the graphical user interface that may be displayed at the browser-based Subscriber-Administrator system 3 as part of block 201 is shown in FIG. 3A. It enables the Subscriber-Administrator user to create a Client by entering the Client name (labeled “Customer Name”), Client Administrator login name and password, and Contact Name and address and contact information, and Location name and address and contact information. Once the Client is set up, the Subscriber-Administrator user turns over the Client-Administrator login name and password to the Client. The Client-Administrator now becomes the Administrator for the Client account. If the Client is currently using the system, the block 201 enables the Subscriber-Administrator to search for the Client and assign the Client to his account.

The Subscriber-Administrator logic 31 also preferably includes a block 203 that enables the Subscriber-Administrator user to create (or change) a contract (or project) that pertains to a specific Client. An example of the graphical user interface that may be displayed at the browser-based Subscriber-Administrator system 3 as part of block 203 is shown in FIG. 3B. It enables the Subscriber-Administrator user to create a contract/project by defining a contract name and time period (e.g., start date and end date). The contract/project may have recurring periods (of one or more types) and may be associated with only one location of the specific Client. The project/contract can also specify rules and conditions that dictate how billing is carried out for the contract period. For example, it can specify that all billing associated with this project/contract is pre-approved. In this case, the billing information does not require approval by the specific Client before it is accumulated into an invoice for submission to the specific Client. In another example, it can specify a number of units (such as man-hours) that are billed free-of-charge during the contract period, or a number of cutoff units (such as man-hours) and associated billing rate adjustment. In this case, in the event that the number of units billed in the contract period exceeds the number of cutoff units, the difference and billing rate adjustment is used to determine the bill. In another example, the contract/project can be setup to automatically generate invoices for specific Clients, or a Client and Location combination. Preferably, only Subscriber-Administrator users are allowed create and maintain contracts and projects.

The Subscriber-Administrator logic 31 also preferably includes a block 205 that enables the Subscriber-Administrator user to create (or change) billing rates associated with particular services (labeled “task) provided by the Subscriber entity to one or more Client entities. An example of the graphical user interface that may be displayed at the browser-based Subscriber-Administrator system 3 as part of block 205 is shown in FIG. 3C. It enables the Subscriber-Administrator user to define a billing rate for a given task. The billing rate can be selectively applied to all Subscriber-staff members (or a particular Subscriber-Staff member), to all clients (or a particular client), and/or to a particular client location. The selections allow the same Subscriber-Staff member to be billed out at varying rates for the same task for different Clients.

The Subscriber-Administrator logic 31 also preferably includes a block 207 that enables the Subscriber-Administrator user to define a Subscriber-Staff member. An example of the graphical user interface that may be displayed at the browser-based Subscriber-Administrator system 3 as part of block 207 is shown in FIG. 3D. It enables the Subscriber-Administrator user to create a Subscriber-Staff member by entering the Subscriber-Staff name, Login name and password, other miscellaneous information (e.g., social security number, gender, salary, etc), and selecting one or more Clients that are affiliated with the Subscriber-Staff member.

The Subscriber-Administrator logic 31 also preferably includes a block 209 that enables the Subscriber-Administrator user to assign (and create) billing services (referred to as “tasks”) associated with particular Client. An example of the graphical user interface that may be displayed at the browser-based Subscriber-Administrator system 3 as part of block 209 is shown in FIG. 3E. It enables the Subscriber-Administrator user to selectively assign one or more tasks to a particular Client (or all Clients), or to possibly a particular Client location. The task is a short description of the services provided by the Subscriber entity. Preferably, the billing tasks associated with a particular Client are used only in conjunction with Time Billing of the particular Client.

The Subscriber-Administrator logic 31 also preferably includes blocks 211 and 213 that enable the Subscriber-Administrator to create (and maintain) Accounts Payable information and Accounts Receivable Information as well as a General Ledger, respectively. Such functionality is well known in the electronic-based accounting arts. The integrated Accounts Payable functionality of block 213 enables the Subscriber-Administrator to easily calculate payment for the Subscriber-Staff member(s). Within this functionality, disbursements to the Subscriber-Staff can be easily generated and managed throughout the system. For example, profit and loss reports can be generated to analyze the billed vs. compensation for any Subscriber-Staff member(s). Such profit and loss reports is derived from the same data that is entered for billing by the Subscriber-Staff member(s) (see block 501 of FIG. 5 and accompanying description). The Subscriber-Staff also has access to disbursements made to them (see block 503 of FIG. 5 and accompanying description), and checks are generated using existing staff information, reducing duplicate data entry. Note that Accounts Payable information and Accounts Receivable information is not available to Client users (e.g., Client-Administrators and/or Client-Staff).

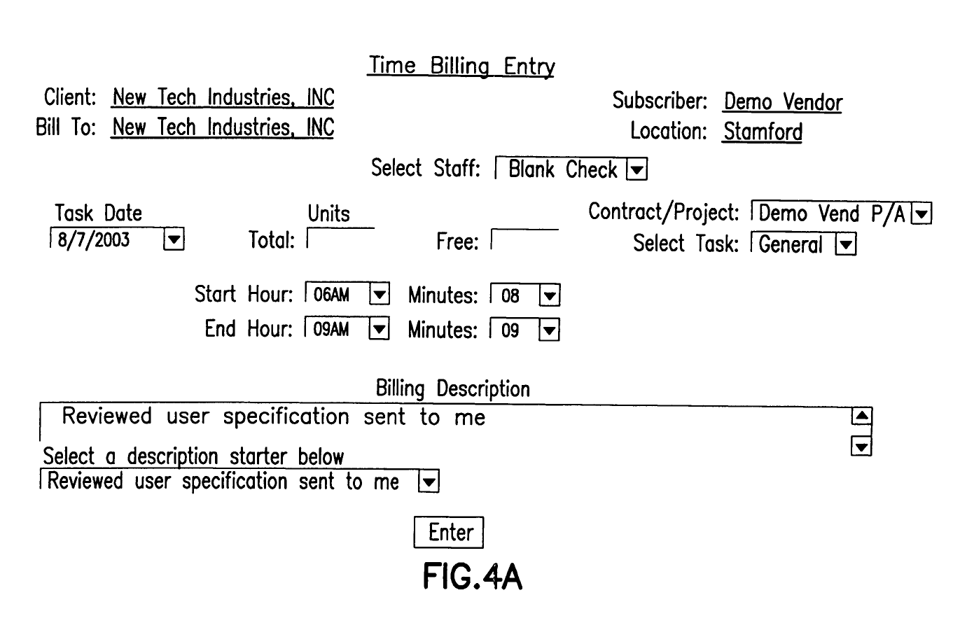

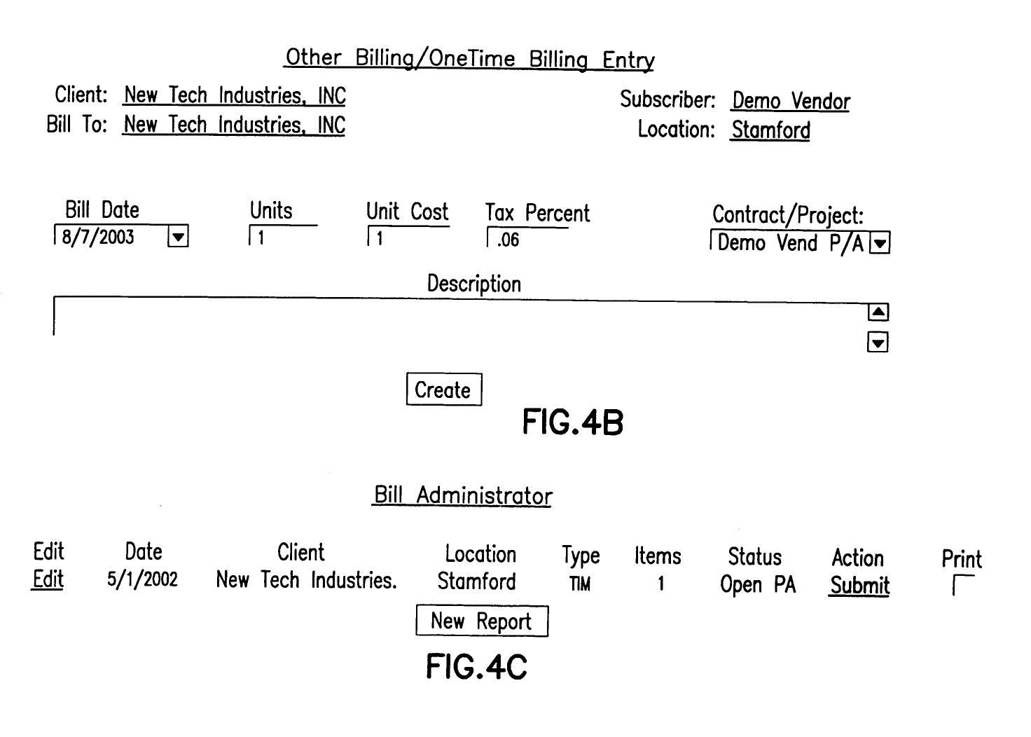

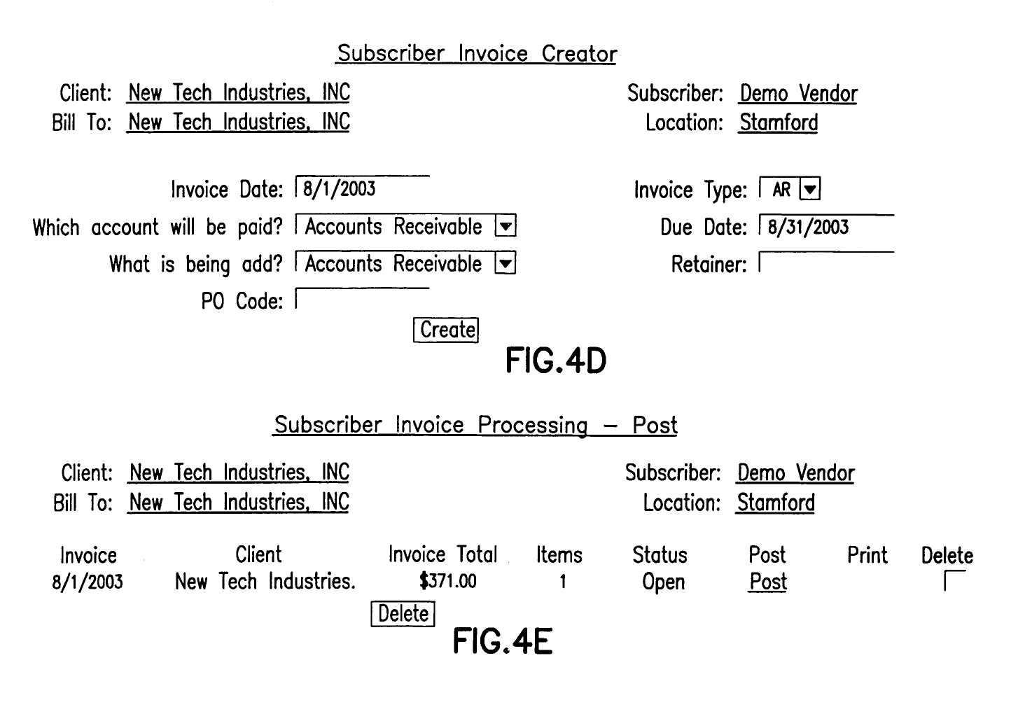

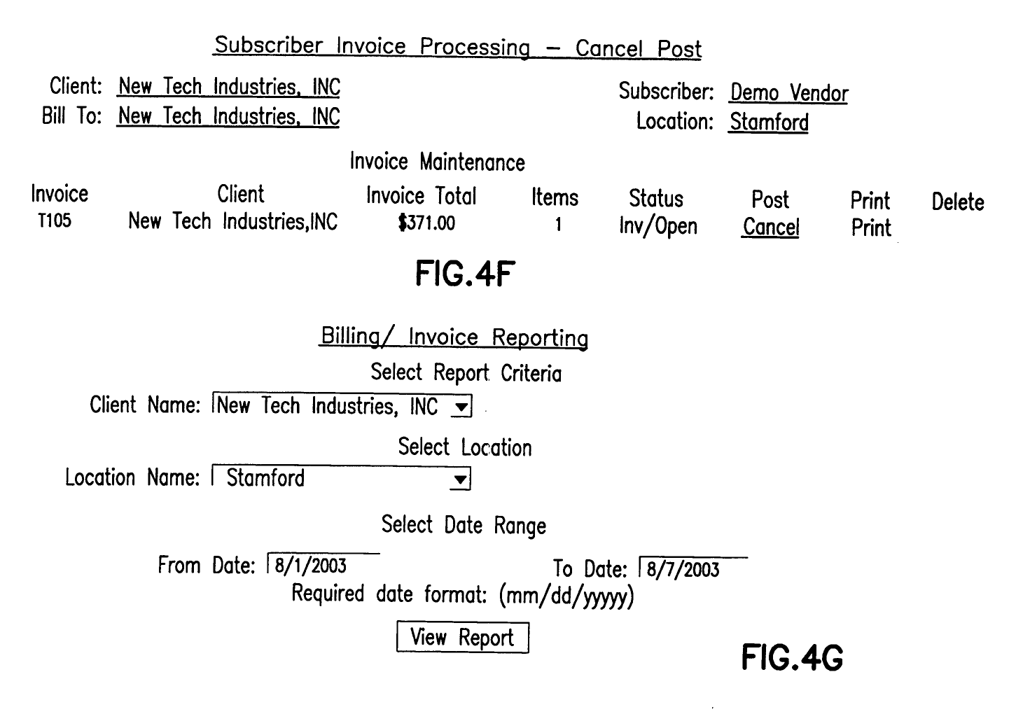

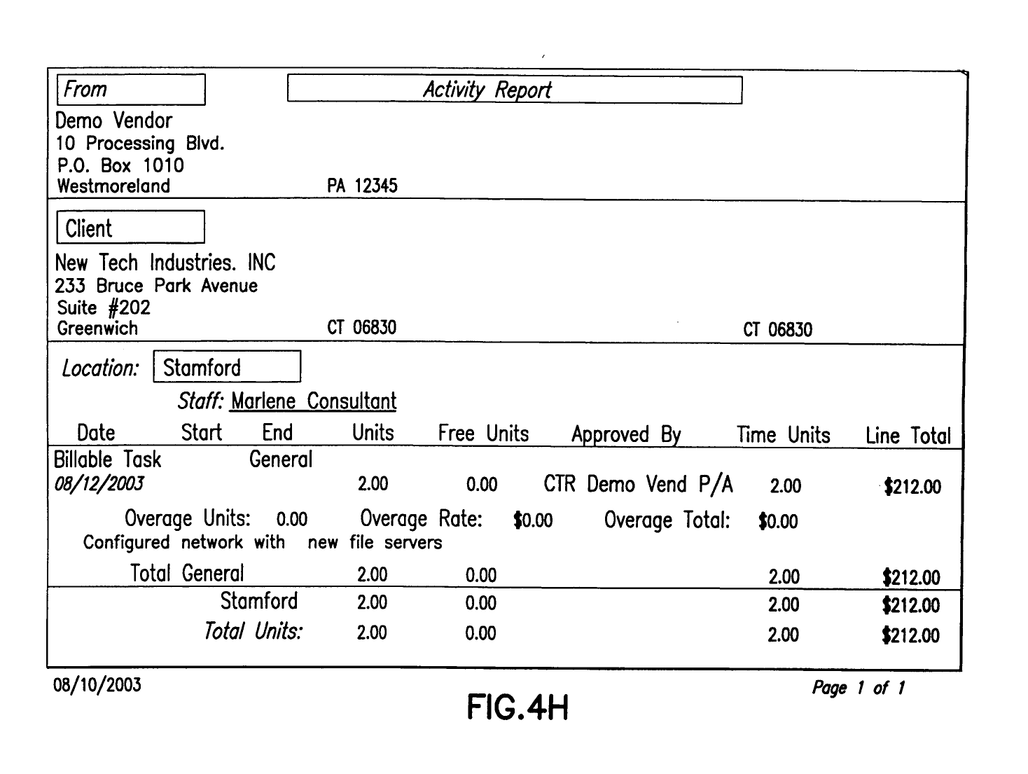

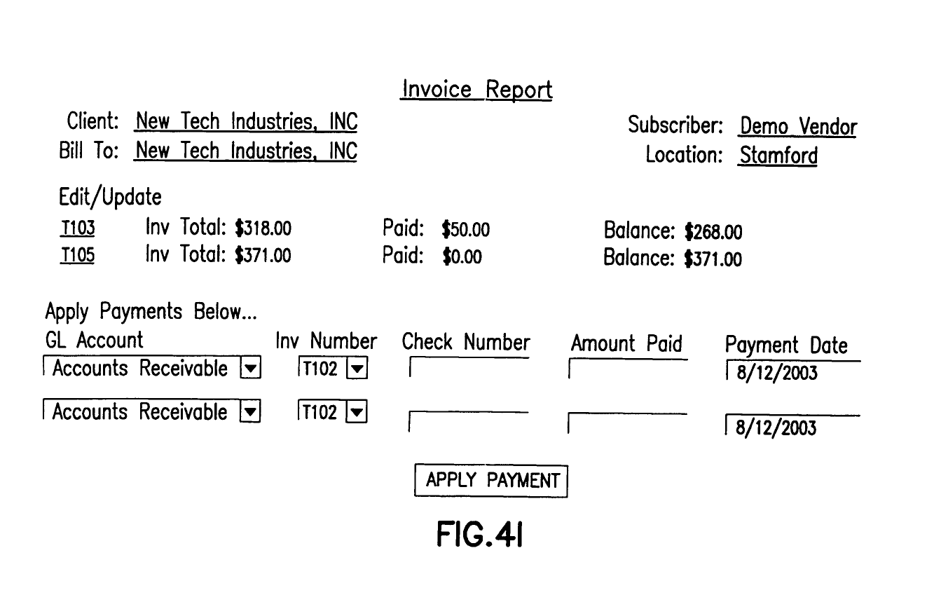

The Subscriber-Administrator logic 31 also preferably includes a block 215 that enables the Subscriber-Administrator user to enter (or update) time-based billing information for a particular Client. An example of the graphical user interface that may be displayed at the browser-based Subscriber-Administrator system 3 as part of block 215 is shown in FIG. 4A. It enables the Subscriber-Administrator user to enter time-based billing information for a specific Client and Location. It also enables the Subscriber-Administrator user to select a contract/project of the particular Client and (and possibly a task assigned to the particular Client and contract/project). The description of the services provided (labeled “billing description”) can be selected from a pull-down menu as shown and then edited. The user selects from a pop-up calendar (or manually enters) the date that the services are provided. Total units are automatically calculated based on the Start and End time entered by the user, unless the user enters a number in the Total. In this case, the Start and End Times are ignored. Free Units are subtracted from the Total Units. The billing information entered (or updated) in block 215 is stored in the database 23 for subsequent access therefrom.

The Subscriber-Administrator logic 31 also preferably includes blocks 217 and 219 that enable the Subscriber-Administrator user to enter one-time billing information or other miscellaneous billing information (such as expenses or other non-time related billing information) for a particular Client, respectively. An example of the graphical user interface that may be displayed at the browser-based Subscriber-Administrator system 3 as part of block 217 is shown in FIG. 4B. It enables the Subscriber-Administrator user to enter billing information for a specific Client and Location. It also enables the Subscriber-Administrator user to select a contract/project of the particular client. The user enters the date that the goods or services are provided, a description of such goods or services to be billed, and cost information (e.g., number of units, unit cost, tax rate) for such goods or services. A similar graphical user interface may be displayed at the browser-based Subscriber-Administrator system 3 as part of block 219. The billing information entered (or updated) in blocks 217 and 219 is stored in the database 23 for subsequent access therefrom.

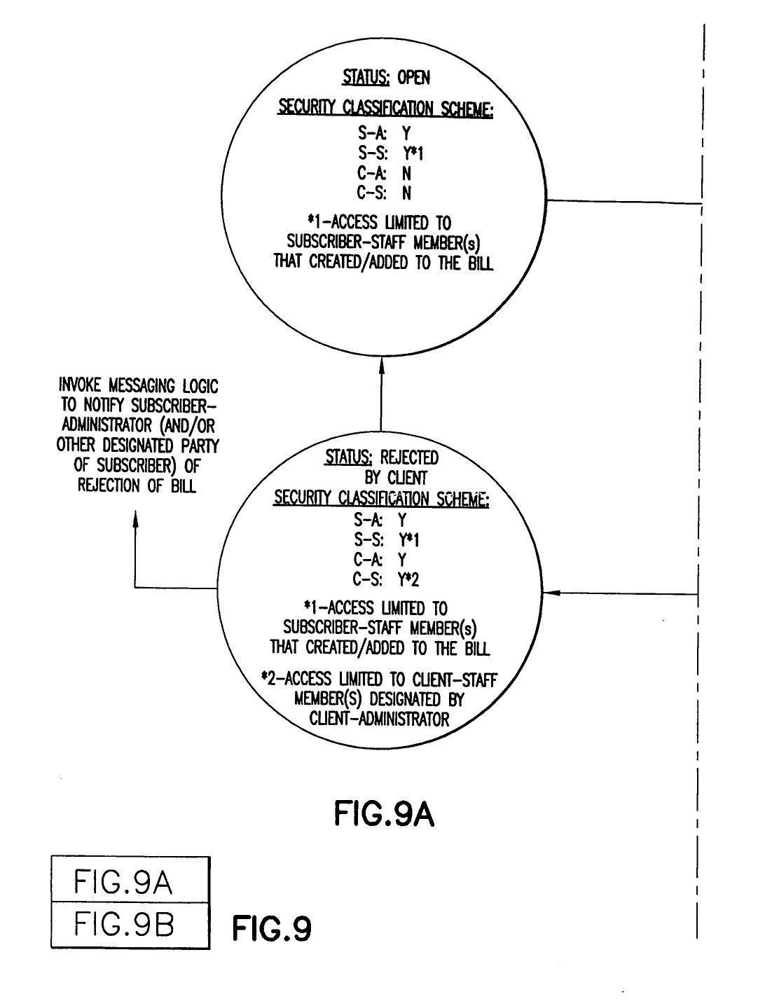

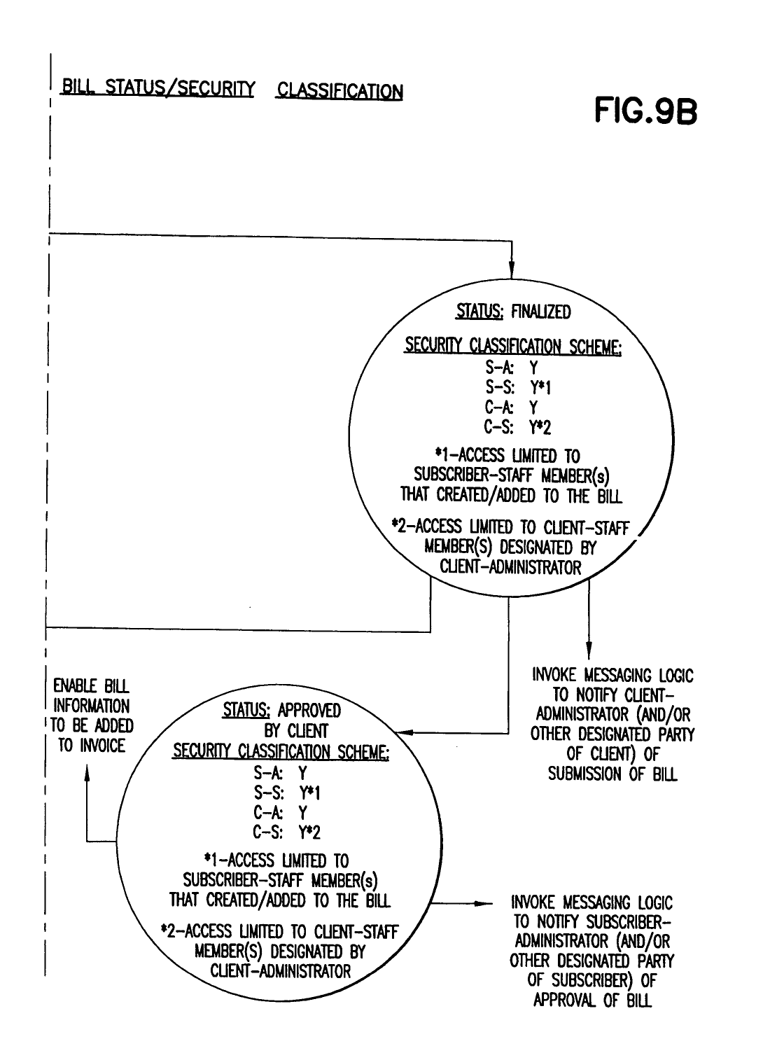

The Subscriber-Administrator logic 31 also preferably includes a block 221 that enables the Subscriber-Administrator user to process and administer billing information stored in the database 23. An example of a graphical user interface that may be displayed at the browser-based Subscriber-Administrator system 3 as part of block 221 is shown in FIG. 4C. It enables a Subscriber-Administrator user to edit/update a billing entry stored in the database 23, and approve the billing entry for submission to the Client. By selecting the Submit action text, the block 221 cooperates with the Data Security Logic 21 to enable one or more Client-Administrator users (and possibly one or more Client-Staff users) to access the billing entry stored in the database 23 for subsequent access therefrom. A more detailed description of the role-based access controls for a billing entry during the invoicing process is set forth below with respect to FIG. 9.

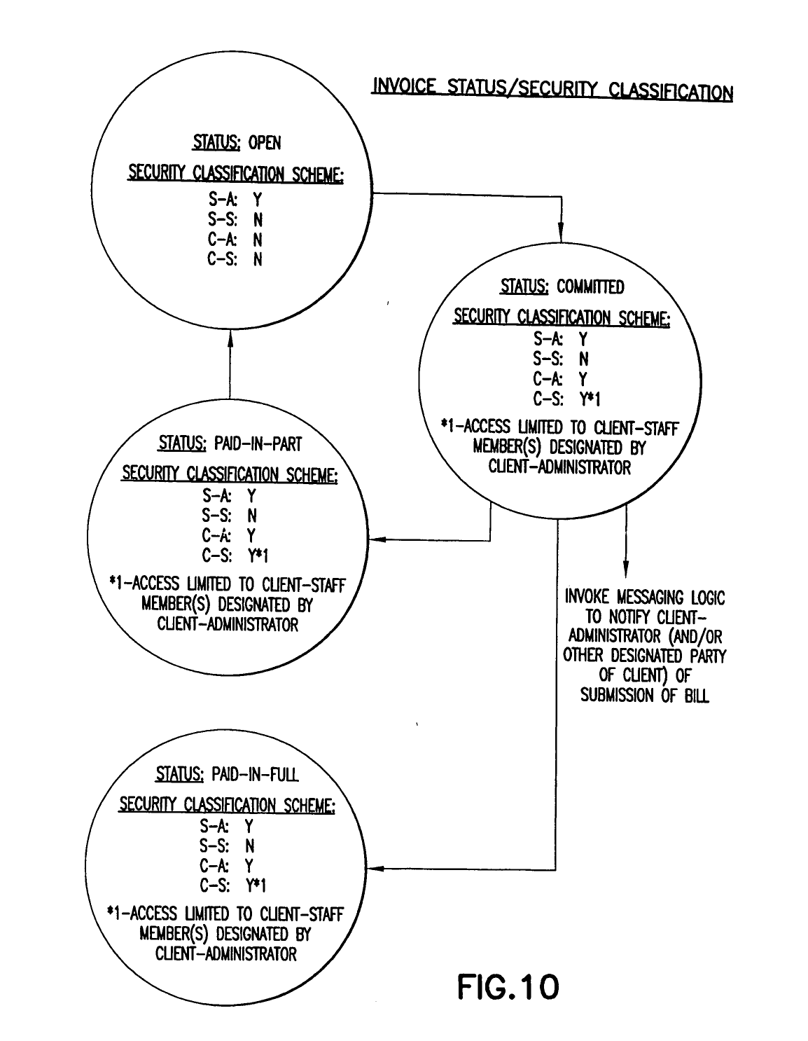

The Subscriber-Administrator logic 31 also preferably includes a block 223 that enables the Subscriber-Administrator user to create (and process) invoices that are derived from the billing information stored in the database 23. An example of the graphical user interfaces that may be displayed at the browser-based Subscriber-Administrator system 3 as part of block 223 are shown in FIGS. 4D, 4E and 4F. The graphical user interface of FIG. 4D enables the Subscriber-Administrator user to create an invoice for a specific Client and Location and user-selected date range. The user enters the date for the invoice and possibly other information (e.g., invoice type, due date, account that will be paid, purchase order code, etc). When the user selects the create button, the functionality of block 221 queries the database 23 to identify the billing information stored therein that pertains to the specific Client and Location and falls within the user-selected date range (and which has been approved by the Client and has not yet been incorporated into an invoice), adds such billing information to an invoice, and displays information for the invoice (such as the invoice date, Client, dollar amount for the invoice, billing descriptions and dates for the billing information from which the invoice is derived, etc). The graphical user interface of FIG. 4E enables the Subscriber-Administrator user to finalize (sometimes referred to herein as “post” or “posting”) an invoice for submission to the Client. By selecting the Post action text, the block 223 cooperates with the Data Security Logic 21 to enable one or more Client-Administrator users (and possibly one or more Client-Staff users) to access the invoice entry stored in the database 23 for subsequent access therefrom. The graphical user interface of FIG. 4F enables the Subscriber-Administrator user to cancel the post of an invoice for submission to the Client. By selecting the Cancel action text, the block 223 cooperates with the Data Security Logic 21 to disable Client-Administrator users (and Client-Staff users) access to the invoice entry stored in the database 23. In this manner, the invoice entry reverts back to being hidden from the Client-Administrator users (and Client-Staff users) of the system. A more detailed description of the role-based access controls of an invoice during the invoicing process is set forth below with respect to FIG. 10. Preferably, an invoice is identified with a date when it is OPEN (i.e., it has not been finalized/posted). After finalization, a number is assigned to the invoice and that is the number that is referenced throughout the life of the invoice.

The Subscriber-Administrator logic 31 also preferably includes a block 225 that enables the Subscriber-Administrator user to generate (and print) reports related to billing entries and invoices stored in the database 23. An example of the graphical user interfaces that may be displayed at the browser-based Subscriber-Administrator system 3 as part of block 225 are shown in FIGS. 4G, 4H and 4I. The graphical user interface of FIG. 4G enables the Subscriber-Administrator user to specify a Client (or Client-Location) and possibly specify a date range and/or other criteria. Upon selection of the view report button, the billing entry(ies) and/or invoices stored in the database 23 that match the user-specified criteria are displayed as a report. An example of a report of billing information is shown in FIG. 4H. An example of a report for invoices is shown in FIG. 4I, which enables the Subscriber-Administrator user to edit, update and process an invoice by selecting the Invoice number action text. It also enables the Subscriber-Administrator user to apply and reconcile payment of the invoices by entering the appropriate information.

Turning now to FIG. 5, there is shown a high-level schematic representation of exemplary functions provided by the Subscriber-Staff logic 33. Such functions include a block 501 that interacts with a browser-based Subscriber-Staff user to enter (or update) billing information for a particular Client. Such billing information can be time-based billing information, one time billing information, or other miscellaneous billing information. The billing information entered (or updated) in block 501 is stored in the database 23 for subsequent access. Graphical user interfaces similar to those described above with respect to FIGS. 4A, 4B and 4C may be displayed at the browser-based Subscriber-Staff system 3 as part of block 501. Preferably, billing entries created by the Subscriber-Staff user can be readily updated by the Subscriber-Staff user until it is submitted by the Subscriber-Staff user. Upon submission, a billing entry can be accessed and viewed by the Subscriber-Staff user, but can be edited only by a Subscriber-Administrator user. The Subscriber-Administrator user then approves the billing entry for submission to the Client as described above with respect to FIG. 4C.

The Subscriber-staff logic 33 also preferably includes block 503 that enables the Subscriber-Staff user to generate (and print) reports related to billing entries created (or updated) by the specific Subscriber-Staff user and stored in the database 23. Graphical user interfaces similar to those described above with respect to FIGS. 4G and 4H may be displayed at the browser-based Subscriber-Staff system 3 as part of block 503. In this case, the displayed billing entries pertain to the Subscriber-staff user. Moreover, the functionality of block 503 preferably enables the Subscriber-Staff user to access disbursements made to the user as part of the Accounts Payable functionality of block 211 (described above with respect to FIG. 2).

In the event that a given Subscriber-staff user performs services for multiple Client entities of the system, it is preferred that the authentication facilities (e.g., login name and password) for the Subscriber-staff user provide access to the billing data for the multiple Clients. This minimizes the complexity of the authentication process of the Subscriber-staff user (for example, the user need not remember and/or enter separate passwords for each Client).

The Subscriber-Staff logic 33 may also provide a number of unique features that are afforded to the Subscriber-Staff members, including generating a report of earnings for a time period (which is preferably specified by user input) and any checks that were generated through the system.

Turning now to FIG. 6, there is shown a high-level schematic representation of exemplary functions provided by the Client-Administrator logic 35. Such functions include a block 601 that interacts with a browser-based Client-Administrator user to create (or update) a Client-Staff member for the Client entity to whom the Client-Administrator belongs. A graphical user interface similar to that described above with respect to FIG. 3D may be displayed at the browser-based Client-Administrator system 9 as part of block 601 is shown in FIG. 3D. It enables the Client-Administrator user to create (or update) a Client-Staff member by entering the Client-Staff name, Login name and password, other miscellaneous information (e.g., social security number, gender, salary, etc), and selecting one or more Subscribers that are affiliated with the Client-Staff member.

The Client-Administrator logic 35 also preferably includes a block 603 that enables the Client-Administrator user to create (or update) one or more locations (e.g., Department, Division, Branch Office, etc.) of the Client entity to which the Client-Administrator logic belongs. Preferably, in block 603, the Client-Administrator user enters (or updates) the name, address, and other miscellaneous information (such as location contact information) for the location. In addition, in block 603, the Client-Administrator user preferably can assign one or more Client-Staff members to one or more locations.

The Client-Administrator logic 35 also preferably includes a block 605 that enables the Client-Administrator user to create (or change) a contract (or project) for the Client entity to whom the Client-Administrator belongs. A graphical user interface similar to that described above with respect to FIG. 3B may be displayed at the browser-based Client-Administrator system 9 as part of block 605. It enables the Client-Administrator user to create a contract/project by defining a contract name and time period (e.g., start date and end date). The contract/project may have recurring periods (of one or more types) and may be associated with one or more locations of the Client. The project/contract can also specify rules and conditions that dictate how billing is carried out for the contract period. For example, it can specify that all billing associated with this project/contract is pre-approved. In this case, the billing information does not require approval by the Client before it is accumulated into an invoice for submission to the Client. In another example, the contract/project can be set up to automatically generate invoices for specific Clients, or a Client and Location combination. Preferably, only Client-Administrator users are allowed create and maintain contracts and projects.

The Client-Administrator logic 35 also preferably includes a block 607 that enables the Client-Administrator user to process and administer billing information stored in the database 23 that pertain to the specific Client to whom the Client-Administrator belongs. An example of a graphical user interface that may be displayed at the browser-based Client-Administrator system 9 as part of block 607 is shown in FIG. 7A. It enables a Client-Administrator user to review and approve billing entries stored in the database 23 that pertain to a specific Subscriber entity. The specific Subscriber entity is associated with the Client entity to whom the Client-Administrator belongs. Approval is accomplished by selecting the Approval All action text for a given billing entry. Preferably, such approval enables the billing entry to be added to an invoice by the specific Subscriber as described below with respect to FIG. 9. In the processing of block 607, billing entries that are “OPEN” and have yet to be “FINALIZED” by the specific Subscriber are not accessible to any Client-Administrator user (or any Client-Staff user). Thus, only the billing entries that have been “FINALIZED” by the specific Subscriber are accessible to the Client-Administrator user for review and approval.

The Client-Administrator logic 35 also preferably includes a block 609 that enables the Client-Administrator user to process and administer invoices that are derived from the billing information stored in the database 23. An example of a graphical user interface that may be displayed at the browser-based Client-Administrator system 9 as part of block 609 is shown in FIG. 7B. It enables the Client-Administrator user to review the invoices for one or more specific Subscribers (and possibly for other user selected criteria such as a particular Subscriber, Client-Location, user-selected date range etc). The specific Subscriber(s) are associated with the Client entity to whom the Client-Administrator belongs. When the user selects the invoice identifier action text, the details of the invoice are displayed for review by the Client-Administrator user. Preferably, block 609 also enables the Client-Administrator user to initiate payment (e.g., full payment or partial payment) for a particular invoice (or provide an indication of such payment), which changes the state of the invoice. This state change is accessible to the Subscriber that submitted the invoice as described below with respect to FIG. 10. In the processing of block 609, invoices that are “OPEN” and have yet to be “COMMITTED” by the specific Subscriber(s) of the Client are not accessible to any Client-Administrator user (or any Client-Staff user). Thus, only the invoices that have been “COMMITTED” by the specific Subscriber(s) are accessible to the Client-Administrator user for review and administration. In block 609, payment of one or more invoices may be accomplished by a payment transaction electronically submitted to the bank of the Subscriber or an Automated Clearing House, by an automated credit card (or debit card) transaction, or by other electronic payment settlements means. Alternatively, the payment of one or more invoices may be accomplished by traditional payment mechanisms, such as mailing a paper check to the specific Subscribers.

The Client-Administrator logic 35 also preferably includes a block 611 that enables the Client-Administrator user to generate (and print) reports related to billing entries and invoices stored in the database 23. A graphical user interface similar to that shown in FIG. 4G may be displayed at the browser-based Client-Administrator system 9 as part of block 611, which enables the Client-Administrator user to specify a Subscriber (and possibly Client-Location) and possibly specify a date range and/or other criteria. Upon selection of the view report button, the billing entry(ies) and/or invoices stored in the database 23 that match the user-specified criteria are displayed as a report. An example of a report of billing information is shown in FIG. 7C. An example of a report for invoices is shown in FIG. 7D.

Turning now to FIG. 8, there is shown a high-level schematic representation of exemplary functions provided by the Client-Staff logic 37. Such functions include a block 801 that interacts with a browser-based Client-Staff user at Client system 9 to generate (and print) reports related to billing entries created (or updated) by the specific Client-Staff user and stored in the database 23. Graphical user interfaces similar to those described above with respect to FIGS. 4G and 4H may be displayed at the browser-based Client-Staff system 9 as part of block 801. In this case, the displayed billing entries pertain to the Client-Staff user.

Turning now to FIG. 9, there is shown a schematic diagram that illustrates various states of a billing entry through the invoicing process carried out by the invoicing system of FIG. 1 in accordance with the present invention. In each state, a set of security classifications (denoted “Y” for access granted, and “N” for access not granted) dictate access to the billing entry by Subscriber-Administrator users (denoted “S-A”), Subscriber-Staff users (denoted “S-S”), Client-Administrator users (denoted “C-A”), and Client-Staff users (denoted “C-S”) in the state.

When a billing entry is created (or updated), it has an “OPEN” state. In the “OPEN” state, Subscriber-Administrator users and those Subscriber-Staff users that created (or added to) the billing entry can access the billing entry. However, the Client-Administrator users and Client-Staff users cannot access the billing entry.

When a Subscriber-Administrator user approves the billing entry, the state of the billing entry transitions to the “FINALIZED” state. In the “FINALIZED” state, Subscriber-Administrator users and those Subscriber-Staff users that created (or added to) the billing entry can access the billing entry. In addition, the Client-Administrator users and those Client-Staff users designated by a Client-Administrator can also access the bill. The application server 11 may cooperate with messaging logic 29 to notify a designated Client-Administrator of the submission of the billing entry by the Subscriber entity to the Client for approval by the client.

When a Client-Administrator user (or possibly a designated Client-Staff user) approves a “FINALIZED” billing entry, the state of the billing entry transitions to the “APPROVED BY CLIENT” state. In the “APPROVED BY CLIENT” state, Subscriber-Administrator users and those Subscriber-Staff users that created (or added to) the billing entry can access the billing entry. In addition, the Client-Administrator users and those Client-Staff users designated by a Client-Administrator can also access the billing entry. The application server 11 may cooperate with messaging logic 29 to notify a designated Subscriber-Administrator of the approval of the billing entry by the Client. Note that in some cases (for example, where the billing entry is associated with a contract/project for which automatic invoicing has been selected), the state of the billing entry automatically transitions from the “FINALIZED” state to the “APPROVED BY CLIENT” state without Client approval. Preferably, in the “APPROVED BY CLIENT” state, the billing information in the billing entry can be added to an invoice; while, in the other states, the billing information in the billing entry cannot be added to an invoice.

When a Client-Administrator user (or possibly a designated Client-Staff user) rejects a FINALIZED” billing entry, the state of the billing entry transitions to the “REJECTED BY CLIENT” state. In the “REJECTED BY CLIENT” state, Subscriber-Administrator users and those Subscriber-Staff users that created (or added to) the billing entry can access the billing entry. In addition, the Client-Administrator users and those Client-Staff users designated by a Client-Administrator can also access the bill. The application server 1 may cooperate with messaging logic 29 to notify a designated Subscriber-Administrator of the rejection of the billing entry by the Client. The Subscriber entity is then free to re-open the billing entry for adjustment, clarification, or resubmission. In this case, the state of the billing entry reverts back to the “OPEN” state and the process begins again.

Turning now to FIG. 10, there is shown a schematic diagram that illustrates various states of an invoice through the invoicing process carried out by the invoicing system of FIG. 1 in accordance with the present invention. In each state, a set of security classifications (denoted “Y” for access granted, and “N” for access not granted) dictate access to the billing entry by Subscriber-Administrator users (denoted “S-A”), Subscriber-Staff users (denoted “S-S”), Client-Administrator users (denoted “C-A”), and Client-Staff users (denoted “C-S”) in the state.

When an invoice is created (or updated), it has an “OPEN” state. In the “OPEN” state, Subscriber-Administrator users can access the invoice. However, the Subscriber-Staff users, Client-Administrator users and Client-Staff users cannot access the invoice.

When a Subscriber-Administrator user posts the invoice, the state of the billing entry transitions to the “COMMITTED” state. In the “COMMITTED” state, Subscriber-Administrator users can access the invoice, while the Subscriber-Staff users cannot access the invoice. In addition, the Client-Administrator users and those Client-Staff users designated by a Client-Administrator can also access the invoice. The application server 11 may cooperate with messaging logic 29 to notify a designated Client-Administrator of the posting of the invoice by the Subscriber entity to the Client for payment by the Client.

When a Client-Administrator user (or possibly a designated Client-Staff user) initiates full-payment (or provides an indication of such full-payment) for a “COMMITTED” invoice, the state of the invoice transitions to the “PAID-IN-FULL” state. In the “PAID-IN-FULL” state, Subscriber-Administrator users can access the invoice, while the Subscriber-Staff users cannot access the invoice. In addition, the Client-Administrator users and those Client-Staff users designated by a Client-Administrator can also access the invoice. The application server 11 may cooperate with messaging logic 29 to notify a designated Subscriber-Administrator of the full-payment of the invoice (or indication thereof) by the Client.

When a Client-Administrator user (or possibly a designated Client-Staff user) initiates partial-payment (or provides an indication of such partial-payment) for a “COMMITTED” invoice, the state of the invoice transitions to the “PAID-IN-PART” state. In the “PAID-IN-PART” state, Subscriber-Administrator users can access the invoice, while the Subscriber-Staff users cannot access the invoice. In addition, the Client-Administrator users and those Client-Staff users designated by a Client-Administrator can also access the invoice. The application server 11 may cooperate with messaging logic 29 to notify a designated Subscriber-Administrator of the partial-payment of the invoice (or indication thereof) by the Client. The Subscriber entity is then free to re-open the invoice for adjustment, clarification, or resubmission. In this case, the state of the invoice reverts back to the “OPEN” state and the process begins again.

Advantageously, the electronic-based invoicing systems of the present invention provides for seller-side processing that enables real-time entry and maintenance of billing information and creation of invoices derived from such billing information as well as buyer-side processing that enables efficient approval and payment of invoices. This highly integrated architecture provide for a lower cost invoicing solution to both sellers and buyers and thus opens up new markets for such advanced invoicing functionality.

There have been described and illustrated herein several embodiments of systems and methods for carrying out electronic bill presentment and invoicing. While particular embodiments of the invention have been described, it is not intended that the invention be limited thereto, as it is intended that the invention be as broad in scope as the art will allow and that the specification be read likewise. Thus, while particular invoicing processes has been disclosed, it will be appreciated that other invoicing processes can be realized as well. For example, and not by way of limitation, the roles of the subscriber users and client users of the system can be readily adapted to accommodate variations in the invoicing process carried out by the system. Such role changes result in adaptations to the logical components of the application server that carry out the invoicing process. Also, while preferred system architectures, graphical user interfaces, and underlying functional logic has been disclosed, it will be understood that modifications thereto can be similarly used. It will therefore be appreciated by those skilled in the art that yet other modifications could be made to the provided invention without deviating from its spirit and scope as claimed.

1. A system for electronic presentment of bills and invoices related to goods and/or services provided by a first entity to a second entity comprising:
first means for authenticating at least one first-entity-class user that is associated with at least one first entity;
second means for authenticating at least one second-entity-class user that is associated with at least one second entity; and
an application server including
a first application component, operably coupled to said first means, that interacts in real-time over a network with an authenticated first-entity-class user to enter, create, maintain, and store billing information and related invoices pertaining to at least one second entity, and
a second application component, operably coupled to said second means, that interacts in real-time over the network with an authenticated second-entity-class user to access portions of said billing information and related invoices pertaining to the authenticated second-entity-class user.

2. The system of claim 1, wherein:
said first application component and said second application component operate in conjunction with data security logic to selectively control second-entity-class user access to portions of said billing information and related invoices that pertain to an authenticated second-entity-class user.

3. The system of claim 1, wherein:
said first application component and said second application component operate in conjunction with data security logic to selectively control first-entity-class user access to portions of said billing information and related invoices that pertain to an authenticated first-entity-class user.

4. The system of claim 1, wherein:
said first means and said second means comprise a web server that operates in a demilitarized zone and that communicates with at least one component of said application server via secure communications through a firewall routing device.

5. The system of claim 1, wherein:
first-entity-class users are logically partitioned into at least two different types each performing functions as part of an invoicing process, and said first application component includes logic modules corresponding to the different types of first-entity-class users, said logic modules interacting with corresponding types of browser-based first-entity-class users to perform said functions as part of the invoicing process.

6. The system of claim 1, wherein:
second-entity-class users are logically partitioned into at least two different types each performing functions as part of an invoicing process, and said second application component includes logic modules corresponding to the different types of second-entity-class users, said logic modules interacting with corresponding types of browser-based second-entity-class users to perform said functions as part of the invoicing process.

7. The system of claim 1, wherein:
said first application component enables access to particular billing information by at least one authenticated second-entity-class user in response to finalization of said particular billing information.

8. The system of claim 7, wherein:
the finalization of said particular billing information is accomplished by interaction over the network with an authenticated first-entity-class user.

9. The system of claim 7, wherein:
said particular billing information cannot be added to an invoice until approved by an authenticated second-entity-class user.

10. The system of claim 1, wherein:
said first application component enables access to particular invoice information by at least one authenticated second-entity-class user in response to posting of said particular invoice information.

11. The system of claim 10, wherein:
the posting of said particular invoice information is accomplished by interaction over the network with an authenticated first-entity-class user.

12. The system of claim 1, wherein:
at least one of said first application component and said second application component cooperate with messaging logic to provide messages to authenticated users of the system regarding status of billing information and invoice information maintained by the system.

13. The system of claim 1, wherein:
at least one of said first application component and said second application component interact in real-time over the network with authenticated users to define at least one project, wherein each given project pertains to a specific second entity and specifies rules and conditions associated with an invoicing process carried out with respect to given project.

14. The system of claim 13, wherein:
each given project includes at least one of a name, time period for the project, information pertaining to the recurring nature of the time period, information regarding time-based billing for the project, and an indication that billing entries associated with the given project can be added to an invoice without prior approval by an authenticated second-entity-class user.

15. A method for electronic presentment of bills and invoices related to goods and/or services provided by at least first entity to at least one second entity comprising:
authenticating at least one first-entity-class user that is associated with at least one first entity;
interacting in real-time over a network with an authenticated first-entity-class user to enter, create, maintain, and store billing information and related invoices pertaining to at one second entity in a database;
authenticating at least one second-entity-class user that is associated with a second entity; and
interacting in real-time over the network with an authenticated second-entity-class user to access portions of said billing information and related invoices pertaining to the authenticated second-entity-class user from said database.

16. The method of claim 15, further comprising:
selectively controlling second-entity-class user access to portions of said billing information and related invoices that pertain to an authenticated second-entity-class user.

17. The method of claim 15, wherein:
selectively controlling first-entity-class user access to portions of said billing information and related invoices that pertain to an authenticated first-entity-class user.

18. The method of claim 15, further comprising:
enabling access to particular billing information by at least one authenticated second-entity-class user in response to finalization of said particular billing information.

19. The method of claim 18, wherein:
the finalization of said particular billing information is accomplished by interaction over the network with an authenticated first-entity-class user.

20. The method of claim 18, wherein:
said particular billing information cannot be added to an invoice until approved by an authenticated second-entity-class user.

21. The method of claim 15, further comprising:
enabling access to particular invoice information by at least one authenticated second-entity-class user in response to posting of said particular invoice information.

22. The method of claim 21, wherein:
the posting of said particular invoice information is accomplished by interaction over the network with an authenticated first-entity-class user.

23. The method of claim 15, further comprising:
automatically generating messages to authenticated users of the system regarding status of billing information and invoice information maintained by the system.

24. The method of claim 15, wherein:
interacting in real-time over the network with authenticated users to define at least one project, wherein each given project pertains to a specific client and specifies rules and conditions associated with the invoicing process carried out with respect to given project.

25. The method of claim 24, wherein:
each given project includes at least one of a name, time period for the project, information pertaining to the recurring nature of the time period, information regarding time-based billing for the project, and an indication that billing entries associated with the given project can be added to an invoice without prior approval by an authenticated second-entity-class user.
